(19) United States
(12) Patent Application Publication
(10) Pub. No.: US 2024/0064097 A1
(43) Pub. Date: Feb. 22, 2024

(54) TRANSFER DEVICE, TRANSFER METHOD, TRANSFER SYSTEM, AND PROGRAM

(71) Applicant: NIPPON TELEGRAPH AND TELEPHONE CORPORATION, Tokyo (JP)

(72) Inventors: Keisuke YAMAGATA, Tokyo (JP); Shinichi YOSHIHARA, Tokyo (JP); Hideo KAWATA, Tokyo (JP)

(73) Assignee: NIPPON TELEGRAPH AND TELEPHONE CORPORATION, Tokyo (JP)

(21) Appl. No.: 18/271,438

(22) PCT Filed: Jan. 13, 2021
(86) PCT No.: PCT/JP2021/000788

§ 371 Date: Jul. 7, 2023

(51) Int. Cl. H04L 45/00; H04L 45/02; H04L 45/24

(52) U.S. Cl. CPC H04L 45/566; H04L 45/02; H04L 45/24

(57) ABSTRACT

A transfer device (10) transfers a packet between a first network (31) and a second network connected to a network device (32) via a first communication path and a second communication path, the network device (32) functioning as a gateway for connecting to the first network (31). The transfer device (10) includes a control unit (16, 22). The network device (32) holds correspondence information indicating a correspondence relationship between each of a first communication port for connecting to the first communication path and a second communication port for connecting to the second communication path, and address information regarding a destination of the packet. The control unit (16, 22) transmits, to the network device (32), an update control signal for the network device (32) to update the address information associated with the first communication port in the correspondence information.

### TECHNICAL FIELD

The present disclosure relates to a transfer device, a transfer method, a transfer system, and a program.

### BACKGROUND ART

FIGS. 18A to 18C are diagrams for explaining communication path switching according to a conventional configuration. A communication system 9 according to the conventional configuration includes a customer network (NW) 91, a network device Y 92, and a network device X 97. The network device X 97 is a device managed by a communication carrier, and the network device Y 92 is a device managed by a customer. The network device Y 92 and the network device X 97 are connected by two paths. In a first path, there are an optical network unit (ONU) 931 connected to the network device Y 92, an optical subscriber unit (OSU) 941, a network device 951, and a network device 961 connected to the network device X 97. In a second path, there are an ONU 932 connected to the network device Y 92, an OSU 942, a network device 952, and a network device 962 connected to the network device X 97. A user-network interface (UNI) is formed between the ONU 931 and the ONU 932, and the network device Y 92. The network device X 97 is connected to the OSU 98 in addition to the network devices 961, 962, and is connected to another network via the ONU 99 and the UNI connected to the OSU 98.

In such a configuration, it is considered that the communication path between the network device Y 92 and the network device X 97 is switched from the first path to the second path. As illustrated in FIG. 18A, before the switching of the communication path, data 901 flows bidirectionally through the first path. At the time of switching the communication path, as illustrated in FIG. 18B, the network device X 97 blocks a communication port on the first path side (909) and opens a communication port on the second path side. This is because if both the first path and the second path are made communicable, a communication failure may occur due to a loop formed by the first path and the second path. As illustrated in FIG. 18C, after the switching of the communication path, data 902 flows bidirectionally through the second path.
Patent Literatures 1 and 2 disclose techniques related to communication path switching.

### CITATION LIST

### Patent Literature

Patent Literature 1: JP 2020-88769 A
Patent Literature 2: JP 2017-59863 A

### SUMMARY OF INVENTION

### Technical Problem

However, unless the destination information of the network device Y 92 is updated, the customer network 91 continues to transmit data to the first path. Therefore, in a case where a communication carrier leads the path switching, it is necessary to send an operator to the place of the network device Y 92 to switch the path in the network device Y 92 at the same timing as the path switching in the network device X 97. In a case where the network device X 97 is connected to a plurality of customer networks, it is necessary to send operators to a plurality of places, and there are problems such as communication interruption due to work errors and occurrence of communication failure due to loops.

In a case of not sending an operator to a customer side, a communication carrier side cannot freely operate the network device Y 92 remotely because the network device Y 92 belongs to the customer side. Therefore, if deletion of old destination information remaining in the network device Y 92 is performed by, for example, control of an aging timer, the second path cannot be used until the timer expires, and thus, there is a possibility that communication interruption occurs for a long time.

An object of the present disclosure is to provide a transfer device, a transfer method, a transfer system, and a program capable of quickly switching a communication path without sending an operator.

### Solution to Problem

In order to solve the above problem, a transfer device according to the present disclosure is a transfer device that transfers a packet between a first network and a second network connected to a network device via a first communication path and a second communication path, the network device functioning as a gateway for connecting to the first network, in which the network device holds correspondence information indicating a correspondence relationship between each of a first communication port for connecting to the first communication path and a second communication port for connecting to the second communication path, and address information regarding a destination of the packet, and the transfer device includes a control unit that transmits, to the network device, an update control signal for the network device to update the address information associated with the first communication port in the correspondence information.

A transfer method according to the present disclosure is a transfer method of a transfer device that transfers a packet between a first network and a second network connected to a network device via a first communication path and a second communication path, the network device functioning as a gateway for connecting to the first network, in which the network device holds correspondence information indicating a correspondence relationship between each of a first communication port for connecting to the first communication path and a second communication port for connecting to the second communication path, and address information regarding a destination of the packet, and the transfer method includes a step of transmitting, to the network device, an update control signal for the network device to update the address information associated with the first communication port in the correspondence information.

A transfer system according to the present disclosure is a transfer system including: a network device functioning as a gateway for connecting to a first network; a transfer device that transfers a packet between the first network and a second network connected to the network device via a first communication path and a second communication path; and a monitoring control device for controlling operation of the transfer device, in which the network device holds correspondence information indicating a correspondence relationship between each of a first communication port for connecting to the first communication path and a second communication port for connecting to the second communication path, and address information regarding a destination of the packet, and the transfer device or the monitoring control device includes a control unit that transmits, to the network device, an update control signal for the network device to update the address information associated with the first communication port in the correspondence information.

The transfer system according to the present disclosure causes a computer to function as the transfer device.

### Advantageous Effects of Invention

According to an embodiment of the present disclosure, it is possible to quickly switch a communication path without sending an operator.

### BRIEF DESCRIPTION OF DRAWINGS

FIG. 1A is a diagram illustrating a configuration example of a communication system according to an embodiment of the present disclosure.

FIG. 1B is a diagram illustrating a configuration example of a communication system according to an embodiment of the present disclosure.

FIG. 2 is a diagram illustrating a hardware configuration example of a network device according to an embodiment of the present disclosure.

FIG. 3 is a diagram illustrating a functional configuration example of the network device according to an embodiment of the present disclosure.

FIG. 4A is a diagram illustrating communication path switching according to an embodiment of the present disclosure.

FIG. 4B is a diagram illustrating communication path switching according to an embodiment of the present disclosure.

FIG. 5A is a diagram illustrating an example of an FDB.

FIG. 5B is a diagram illustrating a structure of an Ethernet frame.

FIG. 6 is a flowchart illustrating an operation procedure of a communication system according to an embodiment of the present disclosure.

FIG. 7A is a diagram illustrating a configuration example of a communication system according to an embodiment of the present disclosure.

FIG. 7B is a diagram illustrating a configuration example of a communication system according to an embodiment of the present disclosure.

FIG. 8 is a diagram illustrating a functional configuration example of the network device according to an embodiment of the present disclosure.

FIG. 9A is a diagram illustrating communication path switching according to an embodiment of the present disclosure.

FIG. 9B is a diagram illustrating communication path switching according to an embodiment of the present disclosure.

FIG. 10 is a flowchart illustrating an operation procedure of a communication system according to an embodiment of the present disclosure.

FIG. 11 is a flowchart illustrating an operation procedure of a communication system according to an embodiment of the present disclosure.

FIG. 12A is a diagram illustrating communication path switching according to an embodiment of the present disclosure.

FIG. 12B is a diagram illustrating communication path switching according to an embodiment of the present disclosure.

FIG. 13 is a flowchart illustrating an operation procedure of a communication system according to an embodiment of the present disclosure.

FIG. 14 is a flowchart illustrating an operation procedure of a communication system according to an embodiment of the present disclosure.

FIG. 15A is a diagram illustrating communication path switching according to an embodiment of the present disclosure.

FIG. 15B is a diagram illustrating communication path switching according to an embodiment of the present disclosure.

FIG. 16 is a flowchart illustrating an operation procedure of a communication system according to an embodiment of the present disclosure.

FIG. 17 is a flowchart illustrating an operation procedure of a communication system according to an embodiment of the present disclosure.

FIG. 18A is a diagram for explaining communication path switching according to a conventional configuration.

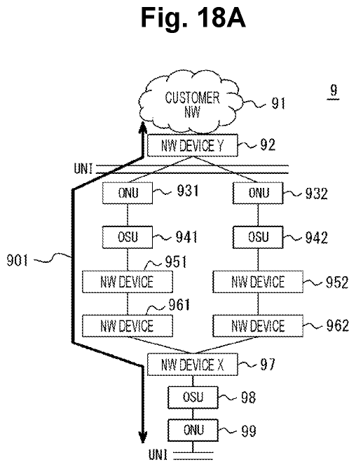

FIG. 18B is a diagram for explaining communication path switching according to a conventional configuration.

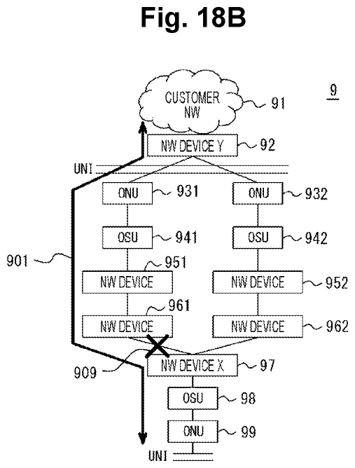

FIG. 18C is a diagram for explaining communication path switching according to a conventional configuration.

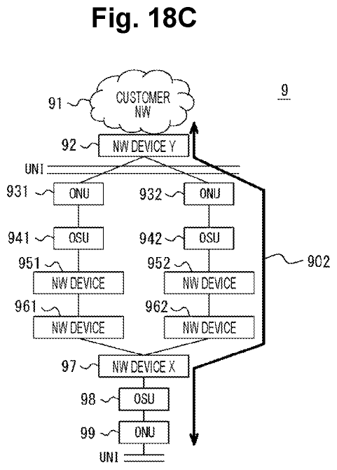

### DESCRIPTION OF EMBODIMENTS

Hereinafter, embodiments of the present disclosure will be described with reference to the drawings. In the drawings, the same or corresponding parts will be denoted by the same reference signs. In description of the embodiments, description of the same or corresponding parts will be omitted or simplified as appropriate.

### First Embodiment

(Communication System)

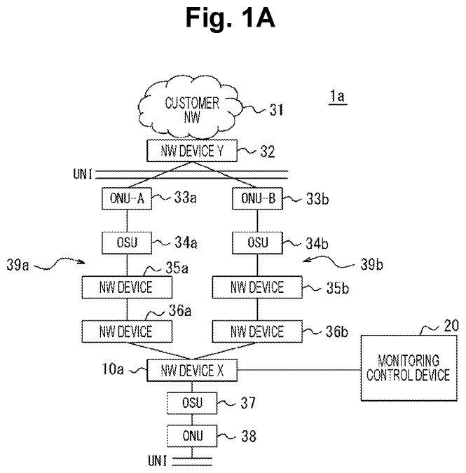

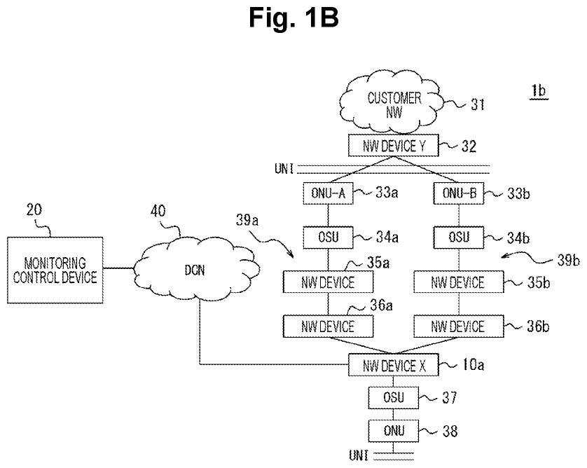

FIGS. 1A and 1B are diagrams illustrating a configuration example of a communication system 1 (1a, lb) as a transfer system according to a first embodiment. The communication system 1 (1a, lb) includes a customer network (NW) 31 as a first network, a network device Y 32, a network device X 10a, and a monitoring control device 20. The network device X 10a and the monitoring control device 20 are devices managed by a communication carrier, and the network device Y 32 is a device managed by a customer. The network device Y 32 functions as a gateway for connecting to the customer network 31. The network device X 10a performs control related to switching of a communication path on the basis of a control signal from the monitoring control device 20. The network device X 10a functions as a transfer device that transfers a packet between the customer network (first network) and another network (second network) to be described later. The customer network 31 is a network managed by a person other than a communication company, and is, for example, an intranet of a company, a network formed by another communication company, a home network, or the like. The communication system 1 (1a, lb) according to the present embodiment is roughly divided into a communication system 1a in which the monitoring control device 20 is directly connected to the network device X 10a, and a communication system 1b in which the monitoring control device 20 is connected to the network device X 10a via a data communication network (DCN) 40. The DCN 40 is an arbitrary network capable of communicating data, and is, for example, the Internet, an intranet, a dedicated communication line, or a combination thereof. Hereinafter, the communication systems 1a and 1b are collectively referred to as a “communication system 1”.

In the communication system 1, the network device Y 32 and the network device X 10a are connected by two communication paths A (route A) 39a and B (route B) 39b. In the communication path A 39a, there are an ONU-A 33a connected to the network device Y 32, an OSU 34a, a network device 35a, and a network device 36a connected to the network device X 10a. In the communication path B 39b, there are an ONU-B 33b connected to the network device Y 32, an OSU 34b, a network device 35b, and a network device 36b connected to the network device X 10a. There may be devices other than the devices illustrated in FIGS. 1A and 1B in the two communication paths A 39a and B 39b. For example, another network such as the Internet may be interposed between the network device 35a and the network device 36a and between the network device 35b and the network device 36b.

In the present embodiment, the two communication paths A 39a, B 39b are configured by optical fiber lines, and the ONU-A 33a and the ONU-B 33b function as terminal devices of the optical fiber lines. However, the line for implementing the two communication paths A 39a, B 39b is not limited to the optical fiber line as long as communication is possible. For example, the two communication paths A 39a, B 39b may be implemented by a metal communication line, a radio communication line, or the like. A UNI is formed between the ONU-A 33a and the ONU-B 33b and the network device Y 32. The network device X 10a is connected to an OSU 37 in addition to the network devices 36a, 36b, and is connected to another network as a second network via the ONU 38 and the UNI connected to the OSU 37. A communication line (communication lines subsequent to the network device X 10a, including a communication line between the network device X 10a and the OSU 37) for the network device X 10a to access another network is referred to as an “access line”. Hereinafter, processing of switching the communication path from the communication path A 39a to the communication path B 39b in a situation where the communication device of the customer network 31 and the communication device in another network to which the network device 10a is connected via the ONU 38 transmit and receive data will be described.

The network device Y 32 includes a port for connection to the ONU-A 33a and a port for connection to the ONU-B 33b. The network device Y 32 holds a forwarding database (FDB) indicating a correspondence relationship between these ports and the MAC address of the destination of the packet. The FDB functions as correspondence information indicating a correspondence relationship between each of a first communication port through which the network device Y 32 is connected to the first communication path and a second communication port through which the network device Y 32 is connected to the second communication path, and address information on a packet destination. When transmitting the packet, the network device Y 32 refers to the FDB and transmits the packet from the port associated with the MAC address of the destination of the packet. When receiving a packet from a communication device of another network, the network device Y 32 has a function of updating the FDB on the basis of the MAC address of the transmission source described in the packet and the port of the network device Y 32 that has received the packet. The network device Y 32 has a function of, when a link of the connected ONU-A 33a or ONU-B 33b is down or the port is blocked, detecting the fact and updating the FDB. That is, the network device Y 32 has a function of associating a MAC address associated with a port connected to the ONU-A 33a or the ONU-B 33b incommunicable in the FDB with another port.

In the present embodiment, focusing on these functions, when the network device X 10a brings the communication path A 39a side into the disconnected state, the network device X 10a or the monitoring control device 20 performs control for updating the FDB of the network device Y 32 without directly operating the network device Y 32. That is, the network device X 10a or the monitoring control device 20 transmits, to the network device Y 32, an update control signal for the network device Y 32 to update the address information associated with the first communication port in the correspondence information (FDB). Specifically, in the present embodiment, the network device X 10a transmits, to the network device Y 32, a packet including a MAC address considered to be managed in association with a port connected to the ONU-A 33a in the FDB of the network device Y 32 via the communication path B 39b. In response to this, the network device Y 32 updates the FDB so as to associate the MAC address with the port connected to the ONU-B 33b existing in the communication path B 39b. Thereafter, the network device Y 32 transmits a packet addressed to the MAC address via the port connected to the ONU-B 32b. Therefore, according to the present embodiment, it is possible to quickly switch a communication path without sending an operator.

(Network Device X)

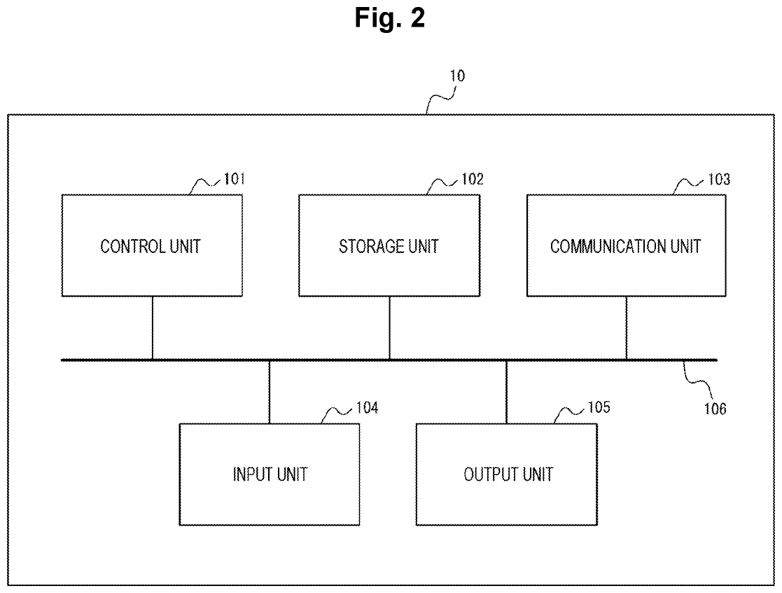

FIG. 2 is a diagram illustrating a hardware configuration example of a network device X 10 according to an embodiment of the present disclosure. The network device X 10 is one information processing device or a plurality of information processing devices capable of communicating with each other. The network device X 10 is not limited thereto and may be an arbitrary electronic device such as a general-purpose computer, dedicated computer, workstation, personal computer (PC), or electronic notepad. As illustrated in FIG. 2, the network device X 10 includes a control unit 101, a storage unit 102, a communication unit 103, an input unit 104, an output unit 105, and a bus 106.

The control unit 101 includes one or more processors. In the embodiment, the “processor” is a general-purpose processor or dedicated processor specialized for specific processing, but is not limited thereto. The processor may be, for example, a central processing unit (CPU), digital signal processor (DSP), or application specific integrated circuit (ASIC). The control unit 101 is connected to each component included in the network device X 10 via the bus 106 so as to be communicate with each component and controls the entire operation of the network device X 10.

The storage unit 102 includes an arbitrary storage module including an HDD, SSD, EEPROM, ROM, and RAM. The storage unit 102 may function as, for example, a primary storage, auxiliary storage, or cache memory. The storage unit 102 stores arbitrary information used for the operation of the network device X 10. For example, the storage unit 102 may store a system program, application program, and various kinds of information received by the communication unit 103. The storage unit 102 is not limited to one built in the network device X 10 and may be an external database or external storage module connected via, for example, a digital input/output port such as a USB. HDD is an abbreviation for hard disk drive. SSD is an abbreviation for solid state drive. EEPROM is an abbreviation for electrically erasable programmable read-only memory. ROM is an abbreviation for read-only memory. RAM is an abbreviation for random access memory. USB is an abbreviation for universal serial bus.

The communication unit 103 includes an arbitrary communication module connectable to another device to communicate therewith by using an arbitrary communication technology. The communication unit 103 may further include a communication control module for controlling communication with another device and a storage module for storing communication data such as identification information necessary for communication with another device.

The input unit 104 includes one or more input interfaces that accept a user's input operation and acquire input information based on the user operation. Examples of the input unit 104 include a physical key, capacitive key, pointing device, touchscreen provided integrally with a display of the output unit 105, and microphone that accepts voice input, but are not limited thereto.

The output unit 105 includes one or more output interfaces that output information to the user to notify the user of the information. Examples of the output unit 105 include a display that outputs information as an image, but are not limited thereto. Note that at least one of the input unit 104 and the output unit 105 described above may be configured integrally with the network device X 10 or may be provided separately.

A function of the network device X 10 is implemented by the processor included in the control unit 101 executing a program according to the present embodiment. That is, the function of the network device X 10 is implemented by software. The program causes a computer to execute processing of steps included in the operation of the network device X 10, thereby causing the computer to implement a function corresponding to the processing of the steps. That is, the program is a program for causing the computer to function as the network device X 10 according to the present embodiment. The program command may be a program code, code segment, or the like for executing a necessary task.

The program may be recorded in a computer-readable recording medium. Using such a recording medium makes it possible to install the program in the computer. Here, the recording medium in which the program is recorded may be a non-transitory (non-temporary) recording medium. The non-transitory recording medium may be a compact disk (CD) read-only memory (ROM), digital versatile disc (DVD) ROM, Blu-ray (registered trademark) disc (BD) ROM, or the like. The program may be distributed by storing the program in a storage of a server and transferring the program from the server to another computer via a network. The program may be provided as a program product.

For example, the computer temporarily stores the program recorded in a portable recording medium or program transferred from the server in the primary storage. Then, the computer causes the processor to read the program stored in the primary storage and causes the processor to execute processing according to the read program. The computer may read the program directly from the portable recording medium and execute processing according to the program. The computer may sequentially execute processing according to the received program each time the program is transferred from the server to the computer. Such processing may be executed by a so-called ASP service that implements a function only by executing an instruction and acquiring a result without transferring the program from the server to the computer. “ASP” is an abbreviation for application service provider. The program includes information used for processing by the computer and information equivalent to the program. For example, data that is not a direct command to the computer but has a property of defining processing of the computer corresponds to “information equivalent to the program”.

Some or all of functions of the network device X 10 may be implemented by dedicated circuits included in the control unit 101. That is, a part or all of the functions of the network device X 10 may be implemented by hardware. Further, the network device X 10 may be implemented by a single information processing device or cooperation of a plurality of information processing devices.

The monitoring control device 20 and the network device Y 32 also have a hardware configuration similar to that of the network device X 10. The functions of the monitoring control device 20 and the network device Y 32 are implemented by software, but some or all of the functions may be implemented by hardware. Further, the monitoring control device 20 and the network device Y 32 may be implemented by a single information processing device or cooperation of a plurality of information processing devices.

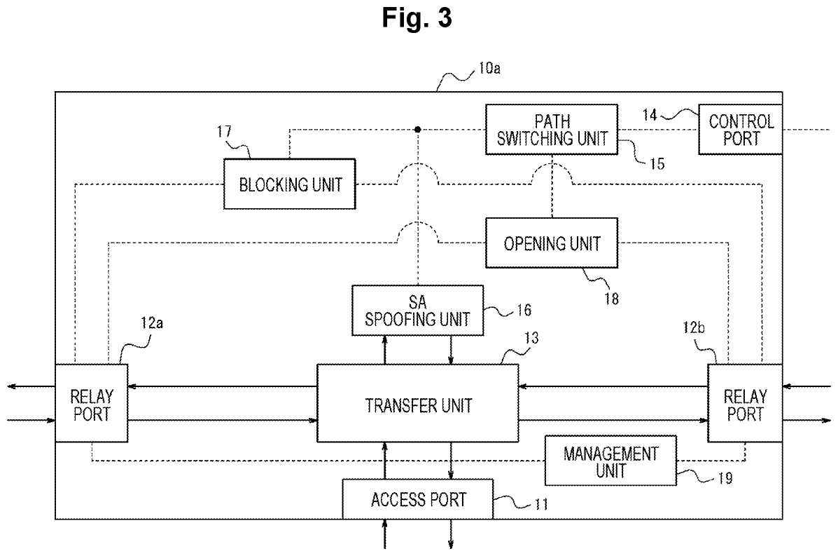

FIG. 3 is a diagram illustrating a functional configuration example of the network device X 10a according to a first embodiment of the present disclosure. The network device X 10a includes an access port 11, two relay ports 12 (12a, 12b), a transfer unit 13, a control port 14, a path switching unit 15, a source address (SA) spoofing unit 16, a blocking unit 17, an opening unit 18, and a management unit 19. These functional elements are implemented by the control unit 101 controlling the components of the network device X 10 illustrated in FIG. 2. The access port 11 is connected to an access line subsequent to the network device X 10a to transmit and receive packets. The relay port 12a as a third communication port is connected to the communication path A 39a and transmits and receives packets. The relay port 12b as a fourth communication port is connected to the communication path B 39b and transmits and receives packets. The transfer unit 13 performs packet transfer processing among the access port 11, the relay port 12 (12a, 12b), and the SA spoofing unit 16. The control port 14 is connected to the monitoring control device 20 and transmits and receives a control signal. Upon receiving the path switching signal from the monitoring control device 20 at the time of switching the communication path, the path switching unit 15 transmits a spoofing processing signal of the SA to the SA spoofing unit 16, a blocking processing signal of the relay port 12 to the blocking unit 17, and an opening processing signal of the relay port 12 to the opening unit 18. The path switching signal is a signal for instructing switching of a communication path. In response to reception of the path switching signal from the path switching unit 15, the SA spoofing unit 16 performs SA spoofing processing of generating a packet in which a source address (SA) which is a MAC address of a transmission source is rewritten and causing the transfer unit 13 to transfer the packet. The packet having the spoofing source address as described above is used by the network device Y 32 to update the FDB to associate the MAC address associated with the port of the communication path A 39a with the port of the communication path B 39b. The blocking unit 17 blocks the relay port 12a or the relay port 12b in response to reception of the blocking processing signal of the relay port 12 from the path switching unit 15. The opening unit 18 opens the relay port 12a or the relay port 12b in response to reception of the opening processing signal of the relay port 12 from the path switching unit 15. The management unit 19 manages whether the state of each of the relay ports 12a, 12b is blocked or opened.

(Communication Path Switching Processing)

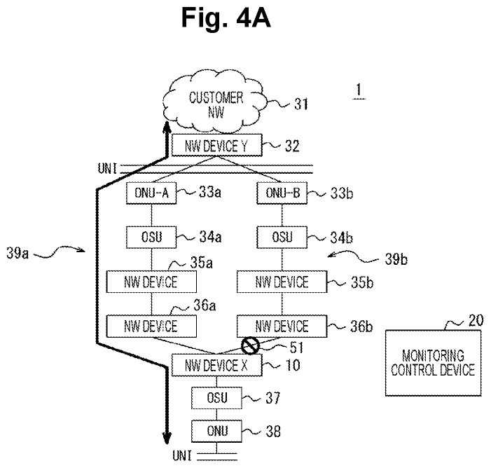

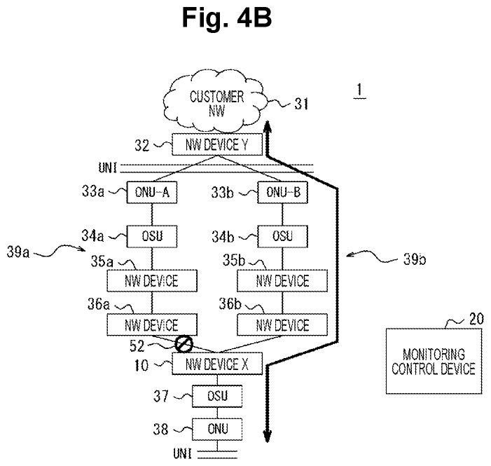

FIGS. 4A and 4B are diagrams illustrating communication path switching in the first embodiment. In the present embodiment, since the mode of the connection relationship between the network device X 10a and the monitoring control device 20 does not matter, FIGS. 4A and 4B do not illustrate the connection relationship between the network device X 10a and the monitoring control device 20.

FIG. 4A illustrates a state before the communication path is switched. In FIG. 4A, data is transmitted and received between the communication device of the customer network 31 and a communication device in another network to which the network device X 10a is connected via the ONU 38 using the communication path A 39a. Here, since the communication path B 39b is not used, the network device X 10a blocks the relay port 12b (51).

When the monitoring control device 20 transmits the path switching signal to the network device X 10a, the network device X 10a performs communication path switching processing for switching the communication path used for transmission and reception of data from the communication path A 39a to the communication path B 39b. The network device X 10a blocks the relay port 12a on the communication path A 39a side (52 in FIG. 4B) and opens the relay port 12b on the communication path B 39b side.

Further, the network device X 10a transmits a packet having a spoofing source address (SA) from the relay port 12b to the network device Y 32 via the communication path B 39b. That is, the network device X 10a transmits, from the relay port 12b, a packet including, in the source address, a MAC address that is considered to be managed in association with the port connected to the ONU-A 33a in the FDB of the network device Y 32. In the FDB of the network device Y 32, the MAC address considered to be associated with the port connected to the ONU-A 33a can be acquired from, for example, the source address included in the packet received via the access port 11. Specifically, the network device X 10a also has an FDB indicating a correspondence relationship between the access port 11 and the MAC address of the communication device of another network on the access port side, and may acquire such a source address with reference to the FDB.

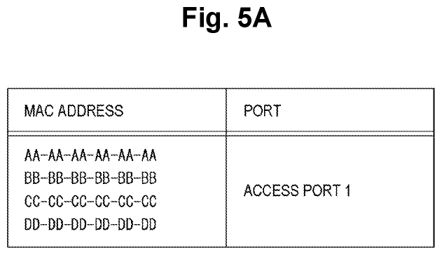

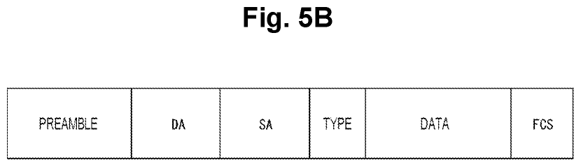

FIG. 5A is a diagram illustrating an example of an FDB included in the network device X 10a. In FIG. 5A, the “access port 1” is information for identifying the access port 11 of the network device X 10a. In the example of FIG. 5A, four MAC addresses “AA-AA-AA-AA-AA-AA”, “BB-BB-BB-BB-BB-BB”, “CC-CC-CC-CC-CC-CC”, and “DD-DD-DD-DD-DD-DD” are associated with the “access port 1”. Since these MAC addresses are recorded at the time of data transmission via the communication path A 39a, it is considered that these MAC addresses are also recorded in the FDB of the network device Y 32 in association with the port connected to the ONU-A 33a. Thus, for each of the MAC addresses (for example, “AA-AA-AA-AA-AA-AA”) associated with the “access port 1”, the network device X 10a transmits a packet having the spoofing source address from the relay port 12b to the network device Y 32 via the communication path B 39b.

FIG. 5B is a diagram illustrating a structure of an Ethernet (Ethernet II) frame. As illustrated in FIG. 5B, the Ethernet frame includes a preamble, a destination address (DA), a source address (SA), a type, data, and a frame check sequence (FCS). When transmitting the packet by the Ethernet frame, the network device X 10a transmits, from the relay port 12b, a packet in which the SA in the frame is set to the MAC address associated with the “access port 1”. Since the packet having the spoofing source address is used to update the FDB of the network device Y 32, the payload portion may be dummy data (for example, “0”) (padding).

When receiving the packet having the spoofing source address via the communication path B 39b, the network device Y 32 updates the FDB so as to associate the source address with the port connected to the ONU-B 33b. Therefore, as illustrated in FIG. 4B, after the FDB is updated, transmission and reception of data using the communication path B 39b is started between the communication device of the customer network 31 and the communication device in another network existing on the access port 11 side of the network device X 10a. As described above, in the present embodiment, since only the source address is spoofing, the format of the packet itself does not change, and the devices other than the network device X 10a can switch the communication path without the need to perform setting change, device exchange, or the like.

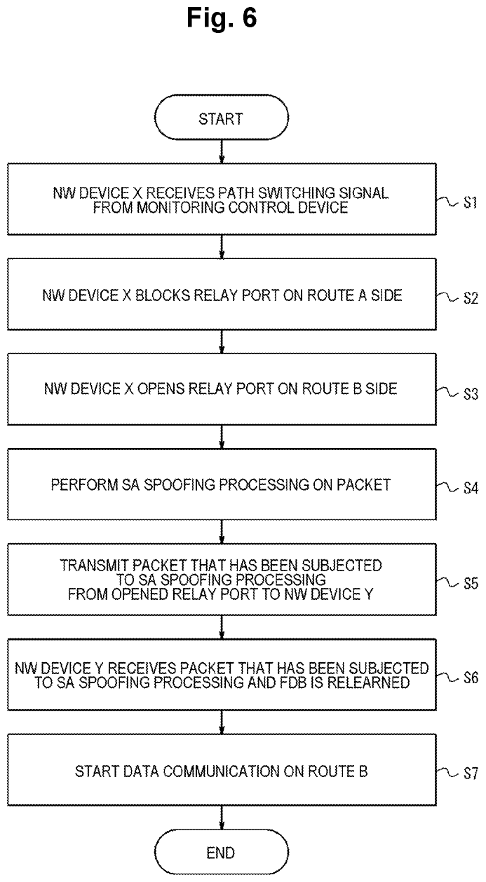

FIG. 6 is a flowchart illustrating an operation procedure of the communication system 1 according to the first embodiment of the present disclosure. The operation of the communication system 1 described with reference to FIG. 6 corresponds to the transfer method according to the present embodiment.

In step S1, the control unit 101 of the network device X 10a receives the path switching signal from the monitoring control device 20 through the control port 14. In the configuration of FIG. 1A, the network device X 10a receives the path switching signal from the directly connected monitoring control device 20, and in the configuration of FIG. 1B, the network device X receives the path switching signal via the DCN 40.

In step S2, the control unit 101 of the network device X 10a performs control such that the path switching unit 15 blocks the relay port 12a on the communication path A 39a side by the blocking unit 17.

In step S3, the control unit 101 of the network device X 10a controls the path switching unit 15 to open the relay port 12b of the communication path B 39b by the opening unit 18.

In step S4, the control unit 101 of the network device X 10a performs the SA spoofing processing on the packet by the SA spoofing unit 16. That is, the control unit 101 performs control such that the SA spoofing unit 16 generates a packet whose transmission source address is each MAC address associated with the access port 11 in the FDB of the network device X 10a.

In step S5, the control unit 101 of the network device X 13a causes the transfer unit 13 to transmit each packet on which the SA spoofing processing has been performed from the released relay port 12b to the network device Y32 via the communication path B 39b.

In step S6, the network device Y 32 receives the packet on which the SA spoofing processing has been performed, and performs relearning of the FDB. That is, the network device Y 32 updates the FDB by associating the transmission source address (MAC address) of the packet on which the SA spoofing processing has been performed with the port connected to the ONU-B 33b. Therefore, the packet addressed to the MAC address is transmitted from the port connected to the ONU-B 33b.

In step S7, data communication on the communication path B 39b is started between the network device X 13a and the network device Y 32. Then, the processing of the flowchart ends.

### Second Embodiment

In the first embodiment, as the control for remotely updating the FDB of the network device Y 32, an example has been described in which the network device X 10a transmits the packet on which the SA spoofing processing has been performed to the network device Y 32 via the communication path (communication path B 39b) of the switching destination. However, the control for updating the FDB of the network device Y 32 is not limited thereto. In the present embodiment, an example will be described in which the network device X 10a or the monitoring control device 20 transmits, to the ONU-A 33a, a signal for causing the ONU-A 33a to perform link down or port closure, and causes the ONU-A 33a to perform link down or port closure. When the ONU-A 33a performs link down or the like, the network device Y 32 detects the link down and updates the FDB so as not to use the port connected to the ONU-A 33a. This enables communication via the communication path B 39b. The same components as those of the first embodiment are denoted by the same reference numerals, and description thereof will be omitted as appropriate.

(Communication System)

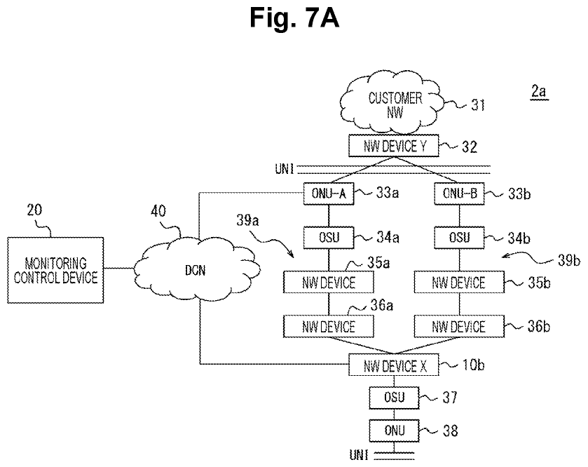

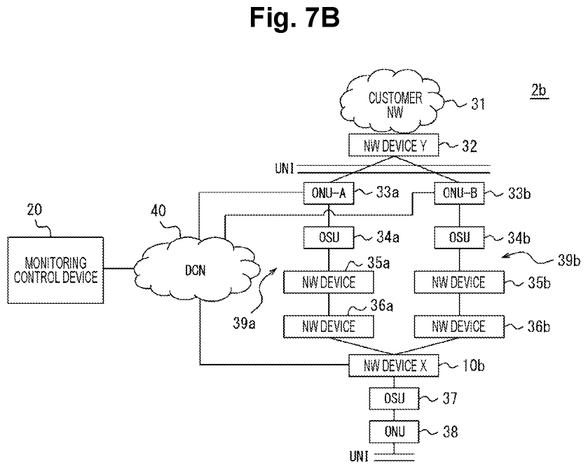

FIGS. 7A and 7B are diagrams illustrating a configuration example of a communication system 2 (2a, 2b) as a transfer system according to a second embodiment. In the communication system 2 (2a, 2b), as similar to the communication system 1b illustrated in FIG. 1B, the monitoring control device 20 and the network device X 10b are connected to the DCN 40. However, unlike the communication system 1b, the communication system 2 (2a, 2b) also connects the ONU-A 33a to the DCN 40. In the communication system 2b, the ONU-B 33b is also connected to the DCN 40. The other components included in the communication system 2 (2a, 2b) are similar to those of the communication system 1. Also in the present embodiment, processing of switching the communication path from the communication path A 39a to the communication path B 39b in a situation where the communication device of the customer network 31 and the communication device in another network to which the network device 10a is connected via the ONU 38 transmit and receive data will be described.

(Network Device X)

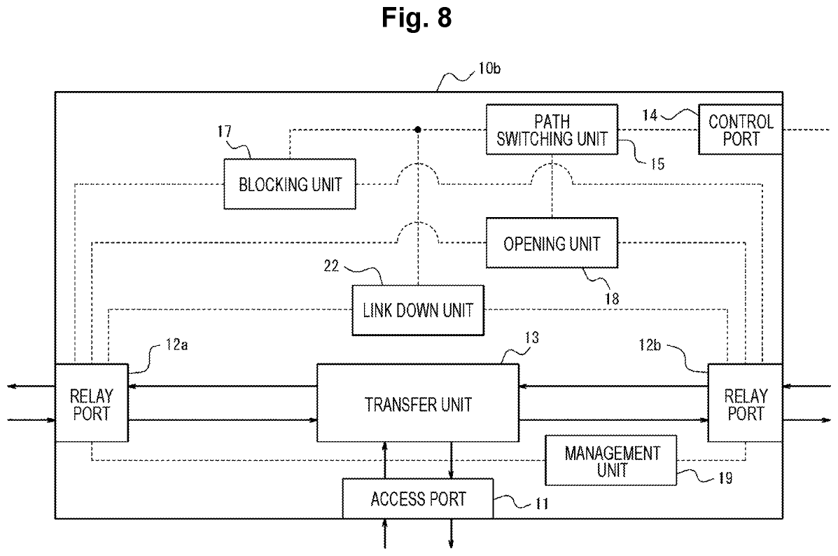

FIG. 8 is a diagram illustrating a functional configuration example of the network device X 10b according to the second embodiment of the present disclosure. As similar to the network device X 10a in FIG. 3, the network device X 10b includes an access port 11, two relay ports 12 (12a, 12b), a transfer unit 13, a control port 14, a path switching unit 15, a blocking unit 17, an opening unit 18, and a management unit 19. However, the network device X 10b is different from the network device X 10a in that it does not include a source address (SA) spoofing unit 16 but includes a link down unit 22. These functional elements are implemented by the control unit 101 controlling the components of the network device X 10 illustrated in FIG. 2. In the present embodiment, at the time of switching the communication path, the path switching unit 15 transmits, to the link down unit 22, a transmission instruction signal of a link down signal that forces the ONU-A 33a to link down in response to reception of a path switching signal from the monitoring control device 20. Further, the path switching unit 15 transmits the closing processing signal of the relay port 12 to the blocking unit 17 and the opening processing signal of the relay port 12 to the opening unit 18, as similar to the network device X 10a. When receiving the transmission instruction signal of the link down signal, the link down unit 22 transmits a link down signal for forcibly lowering the link of the ONU-A 33a connected to the network device Y 32 to the ONU-A 33a as a destination.

Note that the link down unit 22 may transmit, instead of the link down signal, a closing signal for closing a port for the ONU-A 33a to connect to the network device Y 32 to the ONU-A 33a as a destination. Hereinafter, an example of a case where a link down signal for causing a link of the ONU-A 33a to be down is transmitted will be described. When the link down signal is transmitted from the monitoring control device 20, the link down signal is not transmitted from the link down unit 22. Other components of network device X 10b are similar to those of network device X 10a.

(Communication Path Switching Processing 1)

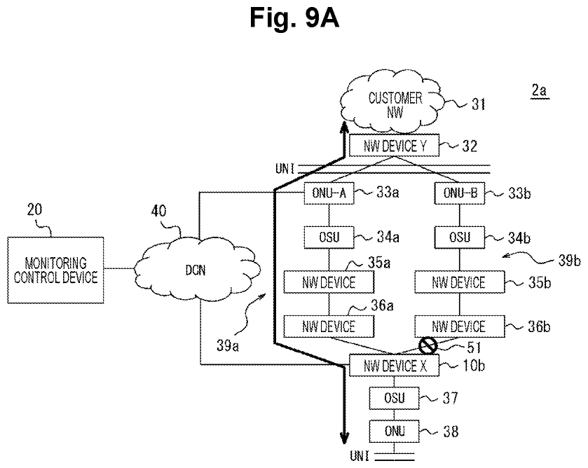

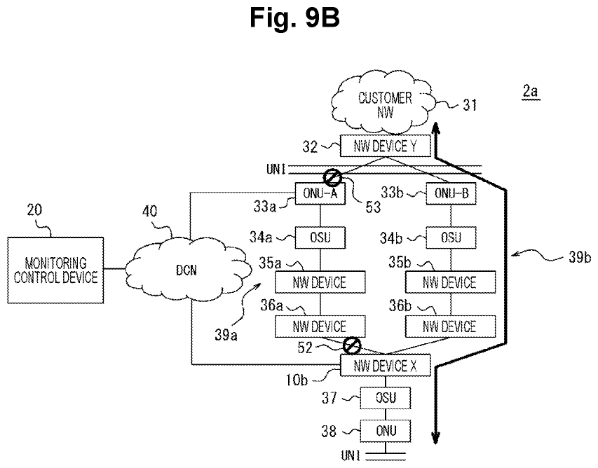

FIGS. 9A and 9B are diagrams illustrating communication path switching in the communication system 2a. FIG. 9A illustrates a state before the communication path switching, and FIG. 9B illustrates a state after the communication path switching. In FIG. 9A, the network device X 10b blocks the relay port 12b on the communication path B 39b side in advance (51). When switching the communication path, the network device X 10b blocks the relay port 12a on the communication path A 39a side (52 in FIG. 9B). Furthermore, the monitoring control device 20 or the network device X 10b transmits a link down signal for causing the link of the ONU-A 33a connected to the network device Y 32 to be down. Here, the order of execution of the blocking of the relay port 12a and the transmission of the link down signal may be changed. When the network device X 10b transmits the link down signal before the relay port 12a is blocked, the network device X 10b may transmit the link down signal via the communication path A 39a or may transmit the link down signal via the DCN 40. When the network device X 10b transmits a link down signal before the relay port 12a is blocked, or when the monitoring control device 20 transmits a link down signal, the link down signal is transmitted via the DCN 40.

In response to the reception of the link down signal, the ONU-A 33a causes the link with the network device Y 32 to be down (53 in FIG. 9B). When detecting the link down with the ONU-A 33a, the network device Y 32 flushes the FDB so as not to use the port connected to the ONU-A 33a, and uses the port connected to the ONU-B 33b when performing communication. The network device X 10b opens the relay port 12b on the communication path B 39b side. This enables bidirectional communication using the communication path B 39b (FIG. 9B).

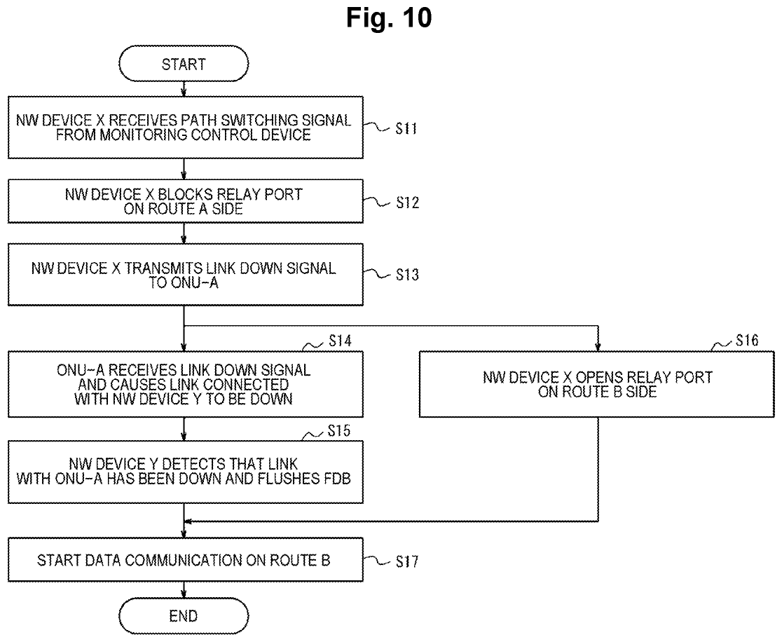

FIG. 10 is a flowchart illustrating an operation procedure of the communication system 2a according to the present embodiment. FIG. 10 illustrates an operation example in a case where the network device X 10b transmits a link down signal in the communication system 2a. The operation of the communication system 2a described with reference to FIG. 10 corresponds to the transfer method according to the present embodiment.

In step S11, the control unit 101 of the network device X 10b receives the path switching signal from the monitoring control device 20 through the control port 14 via the DCN 40.

In step S12, the control unit 101 of the network device X 10b performs control such that the path switching unit 15 blocks the relay port 12a on the communication path A 39a side by the blocking unit 17.

In step S13, the control unit 101 of the network device X 10b causes the link down unit 22 to transmit a link down signal to the ONU-A 33a. The order of step S12 and step S13 may be changed. As described above, when transmitting the link down signal before blocking the relay port 12a, the network device X 10b transmits the link down signal via either the communication path A 39a or the DCN 40. When transmitting the link down signal after blocking the relay port 12a, the network device X 10b transmits the link down signal via the DCN 40.

In step S14, the ONU-A 33a receives the link down signal and causes the link with the network device Y 32 to be down.

In step S15, the network device Y 32 detects that the link with the ONU-A 33a is down, and flushes the FDB. As a result, the FDB is updated so as not to use the port connected to the ONU-A 33a, and communication via the port for connection with the communication path B 39b becomes possible.

In step S16, the control unit 101 of the network device X 10b controls the path switching unit 15 to open the relay port 12b of the communication path B 39b by the opening unit 18. The processing of step S16 is performed in parallel with the processing of steps S14 and S15.

In step S17, data communication on the communication path B 39b is started between the network device X 13b and the network device Y 32. Then, the processing of the flowchart ends.

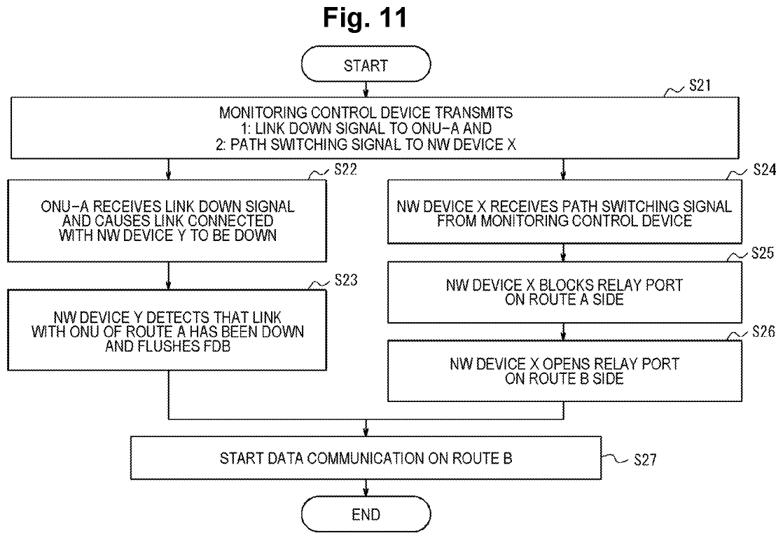

FIG. 11 is a flowchart illustrating an operation procedure of the communication system 2a according to the present embodiment. FIG. 11 illustrates an operation example in a case where the monitoring control device 20 transmits a link down signal in the communication system 2a. The operation of the communication system 2a described with reference to FIG. 11 corresponds to the transfer method according to the present embodiment.

In step S21, the monitoring control device 20 transmits a link down signal to the ONU-A 33a via the DCN 40. Further, the monitoring control device 20 transmits a path switching signal to the network device X 10b via the DCN 40.

In step S22, the ONU-A 33a receives the link down signal and causes the link with the network device Y 32 to be down.

In step S23, the control unit 101 of the network device Y 32 detects that the link with the ONU-A 33a is down, and flushes the FDB. As a result, the FDB is updated so as not to use the port connected to the ONU-A 33a, and communication via the port for connection with the communication path B 39b becomes possible.

On the other hand, in step S24, the control unit 101 of the network device X 10b controls the control port 14 to receive the path switching signal from the monitoring control device 20 via the DCN 40.

In step S25, the control unit 101 of the network device X 10b performs control such that the path switching unit 15 blocks the relay port 12a on the communication path A 39a side by the blocking unit 17.

In step S26, the control unit 101 of the network device X 10b controls the path switching unit 15 to open the relay port 12b of the communication path B 39b by the opening unit 18. The processing of steps S24 to S26 is performed in parallel with the processing of steps S22 and S23.

In step S27, data communication on the communication path B 39b is started between the network device X 13b and the network device Y 32. Then, the processing of the flowchart ends.

(Communication Path Switching Processing 2)

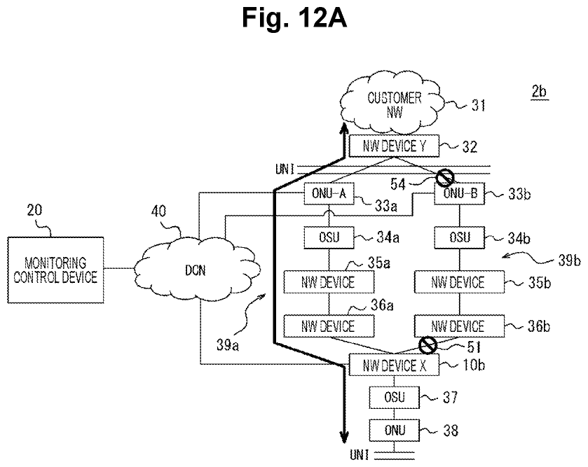

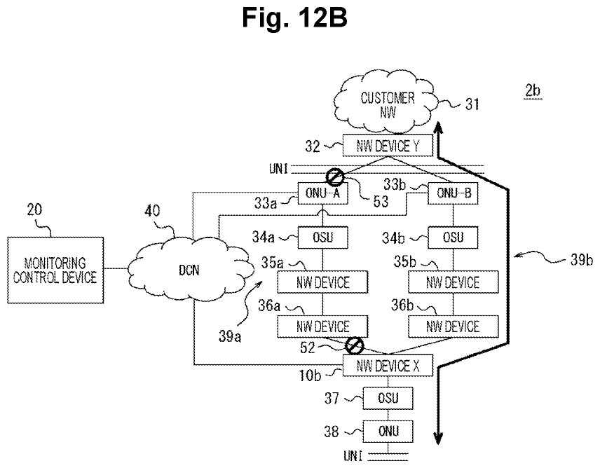

FIGS. 12A and 12B are diagrams illustrating communication path switching in the communication system 2b. FIG. 12A illustrates a state before the communication path switching, and FIG. 12B illustrates a state after the communication path switching. In FIG. 12A, the network device X 10b blocks the relay port 12b on the communication path B 39b side in advance (51). Further, the ONU-B 32b blocks a port for connection with the network device Y 32 in advance (54). When switching the communication path, the network device X 10b blocks the relay port 12a on the communication path A 39a side (52 in FIG. 12B). Furthermore, the monitoring control device 20 or the network device X 10b transmits a link down signal for causing the link of the ONU-A 33a connected to the network device Y 32 to be down. Here, as similar to the communication path switching processing 1, the order of execution of the blocking of the relay port 12a and the transmission of the link down signal may be changed.

In response to the reception of the link down signal, the ONU-A 33a causes the link with the network device Y 32 to be down (53 in FIG. 12B). When detecting the link down with the ONU-A 33a, the network device Y 32 flushes the FDB so as not to use the port connected to the ONU-A 33a, and uses the port connected to the ONU-B 33b when performing communication. The network device X 10b opens the relay port 12b on the communication path B 39b side. Further, the monitoring control device 20 or the network device X 10b transmits a signal for opening a port through which the ONU-B 32b is connected to the network device Y 32 to the ONU-B 32b via the DCN 40. In response to the reception of this signal, the ONU-B 32b opens the port for connection with the network device Y 32. This enables bidirectional communication using the communication path B 39b (FIG. 12B).

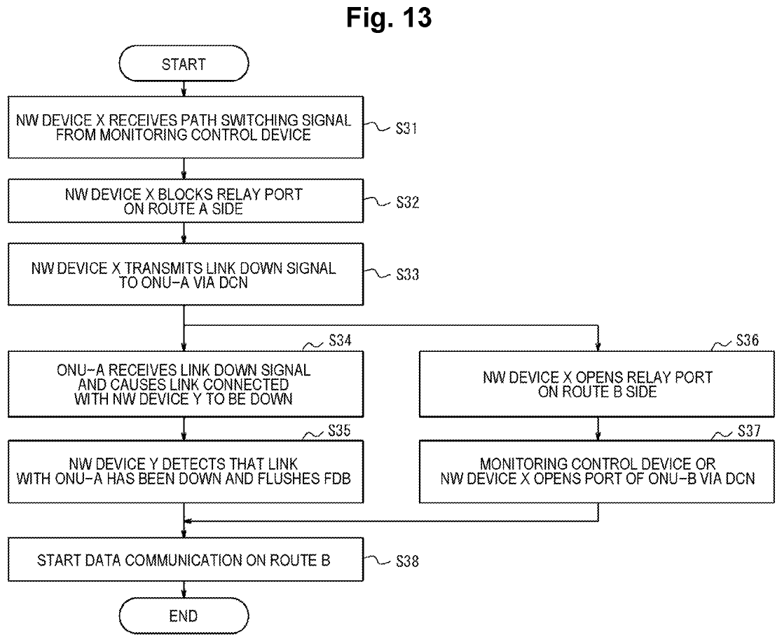

FIG. 13 is a flowchart illustrating an operation procedure of the communication system 2b according to the present embodiment. FIG. 13 illustrates an operation example in a case where the network device X 10b transmits a link down signal in the communication system 2b. The operation of the communication system 2b described with reference to FIG. 13 corresponds to the transfer method according to the present embodiment.

Steps S31 to S36 in FIG. 13 are the same as the processing in steps S11 to S16 in FIG. 10.

In step S37, the monitoring control device 20 or the network device X 10b transmits a signal for opening a port through which the ONU-B 32b is connected to the network device Y 32 to the ONU-B 32b via the DCN 40. In response to the reception of this signal, the ONU-B 32b opens the port for connection with the network device Y 32. The processing of steps S36 and 37 is performed in parallel with the processing of steps S34 and S35.

In step S38, data communication on the communication path B 39b is started between the network device X 13b and the network device Y 32. Then, the processing of the flowchart ends.

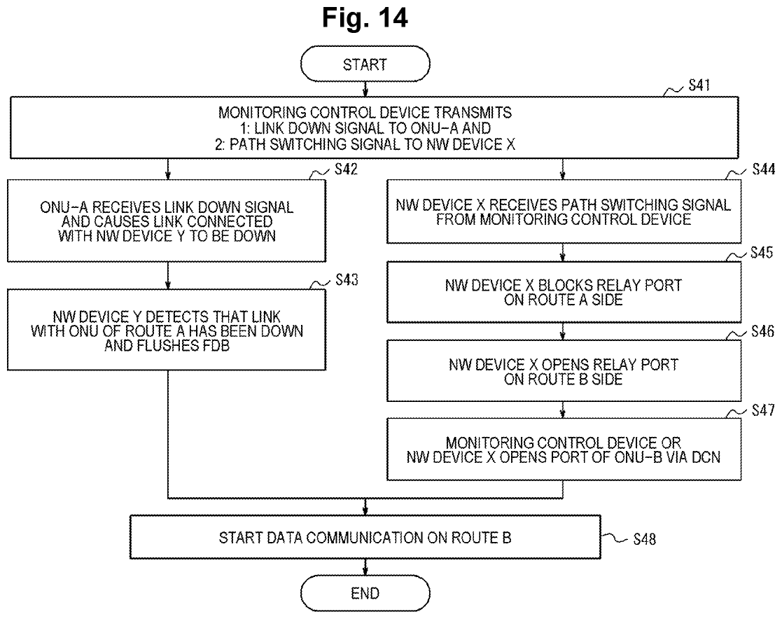

FIG. 14 is a flowchart illustrating an operation procedure of the communication system 2b according to the present embodiment. FIG. 14 illustrates an operation example in a case where the monitoring control device 20 transmits a link down signal in the communication system 2b. The operation of the communication system 2b described with reference to FIG. 14 corresponds to the transfer method according to the present embodiment.

Steps S41 to S46 in FIG. 14 are the same as the processing in steps S21 to S26 in FIG. 11.

In step S47, the monitoring control device 20 or the network device X 10b transmits a signal for opening a port through which the ONU-B 32b is connected to the network device Y 32 to the ONU-B 32b via the DCN 40. In response to the reception of this signal, the ONU-B 32b opens the port for connection with the network device Y 32. The processing of steps S44 to S47 is performed in parallel with the processing of steps S42 and S43.

In step S48, data communication on the communication path B 39b is started between the network device X 13b and the network device Y 32. Then, the processing of the flowchart ends.

### Third Embodiment

In the first and second embodiments, the example in which one customer network 31 and one network device Y 32 are present has been described. In the present embodiment, an example will be described in which the communication path is switched in a case where there are a plurality of the customer network 31 and the network device Y 32. The same components as those of the first embodiment and the second embodiment are denoted by the same reference numerals, and description thereof will be omitted as appropriate.

(Communication Path Switching Processing)

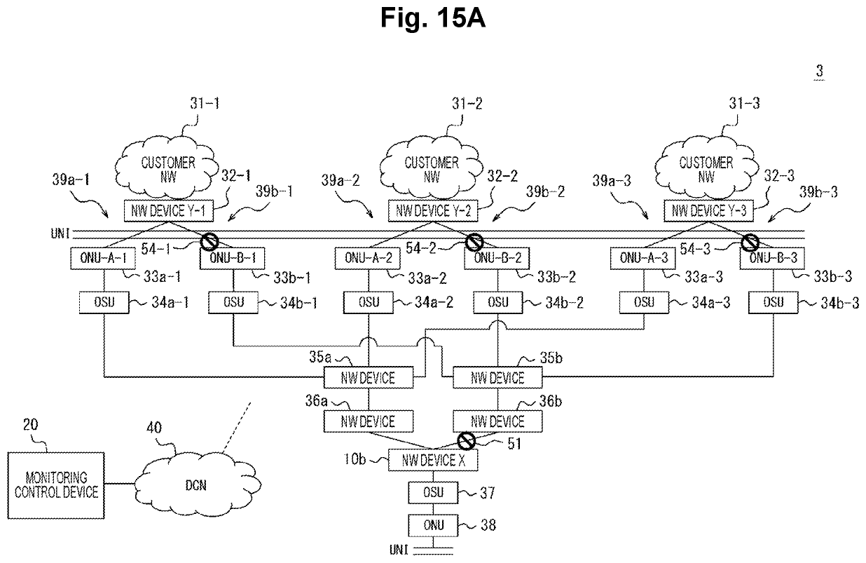

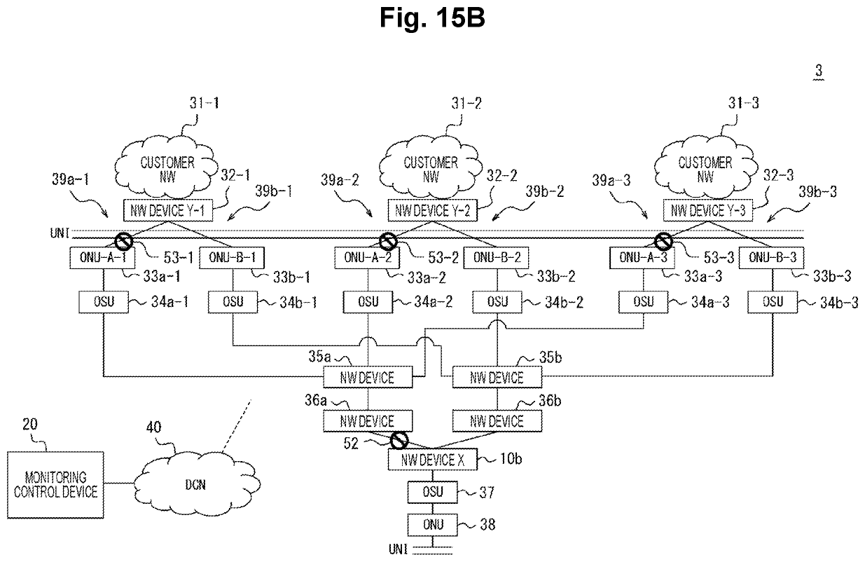

FIGS. 15A and 15B are diagrams illustrating communication path switching in the third embodiment. The communication system 3 as a transfer system according to the present embodiment includes customer networks (NW) 31-1 to 31-3, network devices Y-1 to Y-3 (32-1 to 32-3), a network device X 10a, and a monitoring control device 20. The network devices Y-1 to Y-3 (32-1 to 32-3) are provided corresponding to the customer networks (NWs) 31-1 to 31-3. In the present embodiment, as an example of a configuration in which there are a plurality of customer networks 31 and network devices Y 32, a case where there are three each will be described, but the customer networks 31 and network devices Y 32 may be present in any number.

In the communication system 3, the network devices Y-1 to Y-3 (32-1 to 32-3) are connected to the network device X 10b through two communication paths A and B, respectively. However, in the present embodiment, the network devices 35a and 36a constituting the communication path A and the network devices 35b and 36b constituting the communication path B are common in relation to all the network devices Y-1 to Y-3 (32-1 to 32-3). That is, the communication path A includes the ONU-A-1 to the ONU-A-3 (33a-1 to 33a-3) connected to the network devices Y-1 to Y-3 (32-1 to 32-3), the OSU 34a-1 to 34a-3, the network device 35a, and the network device 36a connected to the network device X 10a. That is, the communication path B includes the ONU-B-1 to the ONU-B-3 (33b-1 to 33b-3) connected to the network devices Y-1 to Y-3 (32-1 to 32-3), the OSU 34b-1 to 34b-3, the network device 35b, and the network device 36b connected to the network device X 10a. Hereinafter, the network devices Y-1 to Y-3 (32-1 to 32-3) may be abbreviated as Y-* (32-*). As similar to this, the ONU-A-1 to the ONU-A-3 (33a-1 to 33a-3) may be abbreviated as ONU-A-* (33a-*), and the ONU-B-1 to the ONU-B-3 (33b-1 to 33b-3) may be abbreviated as ONU-B-* (33b-*). In the present embodiment, the monitoring control device 20 is communicably connected to the ONU-A-* (33a-*) and the ONU-B-*(33b-*) via the DCN 40.

In the present embodiment, an example will be described in which the network device X 10a or the monitoring control device 20 transmits, to each of the ONU-A-* (33a-*), a signal for causing the ONU-A-* (33a-*) to perform link down or port closure, and causes the ONU-A-* (33a-*) to perform link down or port closure. As similar to the second embodiment, when the ONU-A-* (33a-*) performs link down or the like, the network device Y 32 detects the link down and updates the FDB so as not to use the port connected to the ONU-A-* (33a-*). This enables communication via the communication path B.

FIG. 15A illustrates a state before the communication path switching, and FIG. 15B illustrates a state after the communication path switching. In FIG. 15A, the network device X 10b blocks the relay port 12b on the communication path B side in advance (51). Further, the ONU-B-* (33b-*) blocks a port for connection with the network device Y-* (32-*) in advance (54-1 to 54-3). When switching the communication path, the network device X 10b blocks the relay port 12a on the communication path A side (52 in FIG. 15B). Furthermore, the monitoring control device 20 or the network device X 10b transmits a link down signal for causing the link of each of the ONU-A-* (33a-*) connected to Y-* (32-*) to be down. Here, as similar to the second embodiment, the order of execution of the blocking of the relay port 12a and the transmission of the link down signal may be changed.

In response to the reception of the link down signal, the ONU-A-* (33a-*) causes the link with the network device Y-* (32-*) to be down (53-1 to 53-3 in FIG. 15B). When detecting the link down with the ONU-A-* (33a-*), the network device Y-* (32-*) flushes the FDB so as not to use the port connected to the ONU-A-* (33a-*), and uses the port connected to the ONU-B-* (33a-*) when performing communication. The network device X 10b opens the relay port 12b on the communication path B side. This enables bidirectional communication using the communication path B (FIG. 15B).

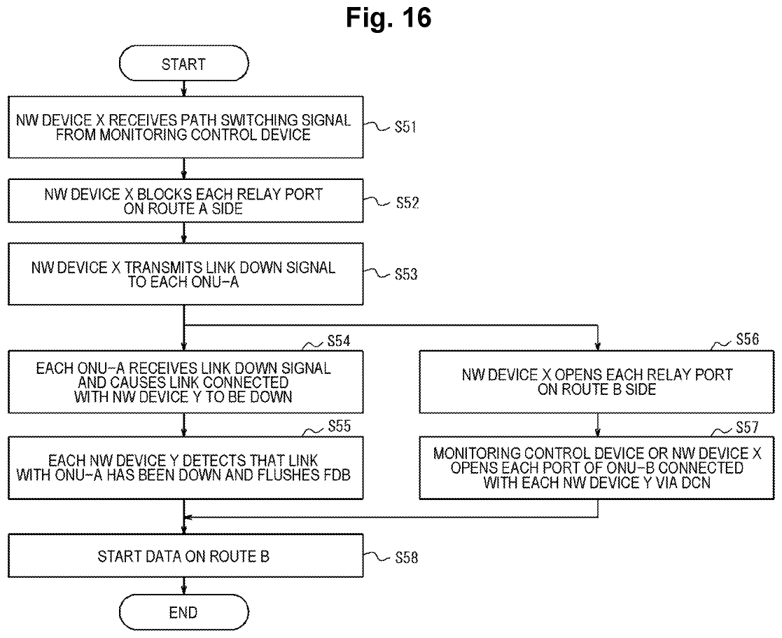

FIG. 16 is a flowchart illustrating an operation procedure of the communication system 3 according to the present embodiment. FIG. 16 illustrates an operation example in a case where the network device X 10b transmits a link down signal in the communication system 3. The operation of the communication system 3 described with reference to FIG. 16 corresponds to the transfer method according to the present embodiment.

In step S51, the control unit 101 of the network device X 10b controls the control port 14 to receive the path switching signal from the monitoring control device 20 via the DCN 40.

In step S52, the control unit 101 of the network device X 10b performs control such that the path switching unit 15 blocks the relay port 12a on the communication path A side by the blocking unit 17.

In step S53, the control unit 101 of the network device X 10b causes the link down unit 22 to transmit a link down signal to each of the ONU-A-* (33a-*). As similar to the above description, the order of step S12 and step S13 may be changed.

In step S54, each of the ONU-A-* (33a-*) receives the link down signal and causes the link with the network device Y-* (32-*) to be down.

In step S55, the network device Y-* (32-*) detects that the link with the ONU-A-* (33a-*) is down, and flushes the FDB. As a result, the FDB is updated so as not to use the port connected to the ONU-A-* (33a-*), and communication via the port for connection with the communication path B becomes possible.

In step S56, the control unit 101 of the network device X 10b controls the path switching unit 15 to open the relay port 12b of the communication path B by the opening unit 18.

In step S57, the monitoring control device 20 or the network device X 10b transmits a signal for opening a port for the ONU-B-* (33b-*) to connect to the network device Y-* (32-*) to each of the ONU-B-* (33b-*) via the DCN 40. In response to the reception of this signal, the ONU-B-* (33b-*) opens each port for connection with the network device Y-* (32-*). The processing of steps S56 and 57 is performed in parallel with the processing of steps S54 and S55.

In step S58, data communication on the communication path B is started between the network device X 13b and the network device Y-* (32-*). Then, the processing of the flowchart ends.

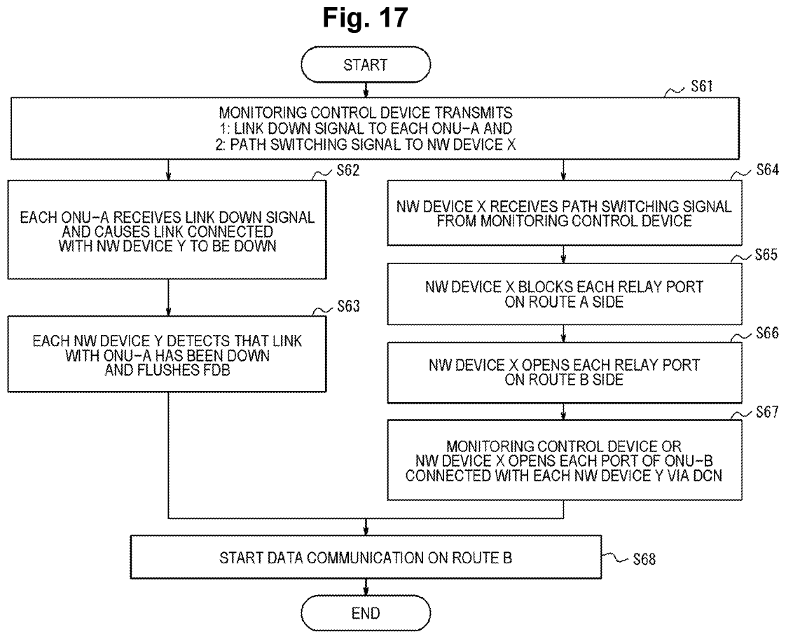

FIG. 17 is a flowchart illustrating an operation procedure of the communication system 3 according to the present embodiment. FIG. 17 illustrates an operation example in a case where the monitoring control device 20 transmits a link down signal in the communication system 3. The operation of the communication system 3 described with reference to FIG. 17 corresponds to the transfer method according to the present embodiment.

In step S61, the monitoring control device 20 transmits a link down signal to the ONU-A-* (33a-*) via the DCN 40. Further, the monitoring control device 20 transmits a path switching signal to the network device X 10b via the DCN 40.

In step S62, each of the ONU-A-* (33a-*) receives the link down signal and causes the link with the network device Y-* (32-*) to be down.

In step S63, the network device Y-* (32-*) detects that the link with the ONU-A-* (33a-*) is down, and flushes the FDB. As a result, the FDB is updated so as not to use the port connected to the ONU-A-* (33a-*), and communication via the port for connection with the communication path B becomes possible.

On the other hand, in step S64, the control unit 101 of the network device X 10b controls the control port 14 to receive the path switching signal from the monitoring control device 20 via the DCN 40.

In step S65, the control unit 101 of the network device X 10b performs control such that the path switching unit 15 blocks the relay port 12a on the communication path A side by the blocking unit 17.

In step S66, the control unit 101 of the network device X 10b controls the path switching unit 15 to open the relay port 12b of the communication path B by the opening unit 18.

In step S67, the monitoring control device 20 or the network device X 10b transmits a signal for opening a port for the ONU-B-* (33b-*) to connect to the network device Y-* (32-*) to each of the ONU-B-* (33b-*) via the DCN 40. In response to the reception of this signal, the ONU-B-* (33b-*) opens the port for connection with the network device Y-* (32-*). The processing of steps S64 to S67 is performed in parallel with the processing of steps S62 and S63.

In step S68, data communication on the communication path B 39b is started between the network device X 13b and each of the network device Y-* (32-*). Then, the processing of the flowchart ends.

In the present embodiment, an example has been described in which the FDB of the network device Y-* (32-*) is updated by transmitting the link down signal to each of the ONU-A-* (33a-*), but the control of updating the FDB of the network device Y-* (32-*) is not limited thereto. For example, as in the first embodiment, the FDB of the network device Y-* (32-*) may be updated by transmitting a packet having the spoofing source address to each of the network devices Y-* (32-*) via the communication path B.

A computer can be suitably used to function as each unit of the network device 10 (10a, 10b) and the monitoring control device 20 described above. Such a computer can be realized by storing a program in which processing contents for realizing the function of each unit of the network device 10 (10a, 10b) are described in a storage unit of the computer and reading and executing the program by a central processing unit (CPU) of the computer. That is, such a program can cause a computer to function as the network device 10 (10a, 10b) described above.

Furthermore, the program may be recorded in a computer-readable medium. By using a computer-readable medium, the program can be installed in a computer. Here, the computer-readable medium in which the program is recorded may be a non-transitory recording medium. The non-transitory recording medium is not particularly limited, and may be, for example, a recording medium such as a CD-ROM or a DVD-ROM. Moreover, the program can also be provided via a network.

The present disclosure is not limited to the embodiments described above. For example, a plurality of blocks in the block diagrams may be integrated, or one block may be divided. The plurality of steps in the flowchart may be executed in parallel or in a different order depending on throughput of a device that executes each step or as necessary, instead of being chronologically executed according to the description. Further, modifications can be made within the gist of the present disclosure.

### REFERENCE SIGNS LIST

1, 2, 3 Communication system
10 Network device X
11 Access port
12 Relay port
13 Transfer unit
14 Control port
15 Path switching unit
16 SA spoofing unit
17 Blocking unit
18 Opening unit
19 Management unit
20 Monitoring control device
22 Link down unit
31 Customer network
32 Network device Y
33, 38 ONU
34, 37 OSU
35, 36 Network device
39a Communication path A
39b Communication path B
40 DCN

1. A transfer device comprising a processor configured to execute operations comprising:
transferring a packet between a first network and a second network through a network device by connecting to the network device via a first communication path and a second communication path,
wherein the network device represents a gateway to the first network,
the network device holds correspondence information, the correspondence information indicates a correspondence relationship between each of a first communication port for connecting to the first communication path and a second communication port for connecting to the second communication path, and address information regarding a destination of the packet; and
transmitting, to the network device, an update control signal for the network device to update the address information associated with the first communication port in the correspondence information.

2. The transfer device according to claim 1, wherein the transmitting further comprises transmitting, as the update control signal, a packet whose source address is the address information associated with the first communication port in the correspondence information, from the second communication path to the network device.

3. The transfer device according to claim 1, the processor further configured to execute operations comprising:
connecting to the first communication path via a terminal device, wherein
the transmitting further comprises transmitting, as the update control signal, a first signal to cause a link to the network device to be down or a second signal to block a port to the network device, to the terminal device.

4. The transfer device according to claim 1, wherein the transmitting further comprises transmitting the update control signal to the network device in response to reception of a path switching signal instructing switching of a communication path from a monitoring control device.

5. The transfer device according to claim 1, the processor further configured to execute operations comprising:
blocking a third communication port for the transfer device to connect to the first communication path; and
opening a fourth communication port for the transfer device to connect to the second communication path.

6. A computer implemented method for transferring by a transfer device, a packet between a first network and a second network connected to a network device via a first communication path and a second communication path using a network device as a gateway for connecting to the first network, comprising:
storing, by the network device, correspondence information indicating a correspondence relationship between each of a first communication port for connecting to the first communication path and a second communication port for connecting to the second communication path, and address information regarding a destination of the packet; and
transmitting, by the transfer device, to the network device, an update control signal for causing the network device to update the address information associated with the first communication port in the correspondence information.

7. A system comprising:
a network device, wherein the network device is configured as a gateway to connect to a first network;
a transfer device, wherein the transfer device is configured to transfer a packet between the first network and a second network connected to the network device via a first communication path and a second communication path; and
a monitoring control device, wherein the monitoring control device controls operation of the transfer device,
wherein the network device holds correspondence information indicating a correspondence relationship between each of a first communication port for connecting to the first communication path and a second communication port for connecting to the second communication path, and address information regarding a destination of the packet, and
either one of the transfer device or the monitoring control device transmits, to the network device, an update control signal for the network device to update the address information associated with the first communication port in the correspondence information.

8. (canceled)

9. The transfer device according to claim 1, wherein the first communication path is distinct from the second communication path.

10. The transfer device according to claim 1, wherein the first network is distinct from the second network.

11. The transfer device according to claim 2, wherein the transmitting further comprises transmitting the update control signal to the network device in response to reception of a path switching signal instructing switching of a communication path from a monitoring control device.

12. The transfer device according to claim 2, the processor further configured to execute operations comprising:
blocking a third communication port for the transfer device to connect to the first communication path; and
opening a fourth communication port for the transfer device to connect to the second communication path.

13. The computer implemented method according to claim 6, wherein the transmitting further comprises transmitting, as the update control signal, a packet whose source address is the address information associated with the first communication port in the correspondence information, from the second communication path to the network device.

14. The computer implemented method according to claim 6, further comprising:
connecting to the first communication path via a terminal device, wherein
the transmitting further comprises transmitting, as the update control signal, a first signal to cause a link to the network device to be down or a second signal to block a port to the network device, to the terminal device.

15. The computer implemented method according to claim 6, wherein the transmitting further comprises transmitting the update control signal to the network device in response to reception of a path switching signal instructing switching of a communication path from a monitoring control device.

16. The computer implemented method according to claim 6, wherein the first communication path is distinct from the second communication path.

17. The computer implemented method according to claim 6, wherein the first network is distinct from the second network.

18. The system according to claim 7, wherein the transmitting further comprises transmitting, as the update control signal, a packet whose source address is the address information associated with the first communication port in the correspondence information, from the second communication path to the network device.

19. The system according to claim 7, wherein the transfer device is further configured to execute operations comprising:
blocking a third communication port for the transfer device to connect to the first communication path; and
opening a fourth communication port for the transfer device to connect to the second communication path.

20. The system according to claim 7, wherein the transmitting further comprises transmitting the update control signal to the network device in response to reception of a path switching signal instructing switching of a communication path from a monitoring control device.

21. The system according to claim 7, wherein the first communication path is distinct from the second communication path, and
the first network is distinct from the second network.
